(19) United States
(12) Patent Application Publication
(10) Pub. No.: US 2012/0091720 A1
(43) Pub. Date: Apr. 19, 2012

(54) Mechanically producing wind power to operate turbines

(76) Inventor: Lena John Piva, Hamilton (CA)

(21) Appl. No.: 12/923,025

(22) Filed: Oct. 18, 2010

(51) Int. Cl. F03D 9/00; H02K 53/00

(52) U.S. Cl. 290/55; 74/DIG. 9

(57) ABSTRACT

When a vehicle moves forward, the total wind power produced is expended uselessly causing a drag on the vehicle. What is new in this invention is that one uses this wind power before it hits the vehicle. This wind power is used to drive a turbine producing electrical energy. This produced electrical energy is used as an added energy source to charge the battery and drive the electric engine.

A moving Vehicle Creating Wind power which is used to operate a turbine to produce electrical energy, when the turbine is mounted on one or more selected positions and connected to the existing electrical input of the vehicle, it will be a energy source to charge the battery and drive the electric engine. The turbine is readily available from any turbine manufacturer and is easily mounted and connected to the present electrical input of the hybrid, the electric and the hybrid electric vehicle.

### BACKGROUND OF THE INVENTION

This invention relates to wind power being produced by a moving vehicle and using this wind power to operate a turbine to produce electrical energy.

### DETAILED DESCRIPTION OF THE INVENTION

A moving vehicle creates wind power which is harnessed to operate a turbine. The turbine is mounted on one or more selected positions of the vehicle. The electrical energy from the turbine is connected to the electrical input of the vehicle and is sent to either the electric motor or the batteries, depending upon the state of the charge (SOC) of the battery pack and the power demanded by the wheels. Distribution is controlled by the electric control unit of the vehicle and the varying size of the opening feeding the produced wind power to the turbine.

At present, various vehicles, such as the electric, the hybrid, and the hybrid electric are available from the manufacturers describing the electric vehicle whose primary source of energy is electricity, gasoline is only used as a secondary source when the battery is low. A gasoline powered engine generator seamlessly provides electricity to power the electrical drive unit while simultaneously sustaining the charge of the battery. This mode of operation extends the additional mileage until the vehicles battery can be charged by the electrical grid.

When the battery is low, the power from the generator is sent to either the electric motor or the batteries, depending on the state of charge (SOC) of the battery pack and the power demanded at the wheels. The distribution is controlled by the electronic control unit(ECU) of the vehicle

The present and previously sold vehicles use the gasoline engine to produce voltages up to 650 volts and be an energy source to charge the battery or to charge the battery and run the electric engine. Some vehicles also use the grid to charge the battery when it is low. This invention can be an added energy source for all of the above.

### SUMMARY OF THE INVENTION

A turbine is installed on a hybrid electric, a hybrid or an electric vehicle. When the vehicle is moving it produces wind power. This wind power is used to produce energy This energy will be used for charging the battery, and running the electric engine The advantage of this invention is that the vehicle will travel further before it is necessary to charge the battery. there will be less fuel consumption, this will save $ and it will be more environmentally friendly.

What I claim as my invention is

1. The produced wind power created by a moving vehicle is used to power a turbine, which produces electrical energy. The produced electrical energy is connected to the vehicle's electrical input and used as an added energy source to charge the battery and drive the electric engine.

2. Mechanically produced wind power is used to operate a turbine to produce electrical energy.
